(19) United States
(12) Patent Application Publication
(10) Pub. No.: US 2014/0064379 A1
(43) Pub. Date: Mar. 6, 2014

(54) VIDEO ENCODING AND DECODING WITH CHROMINANCE SUB-SAMPLING

(71) Applicant: BRITISH BROADCASTING CORPORATION, London (GB)

(72) Inventors: Marta Mrak, London (GB); Andrea Gabriellini, Guilford (GB)

(21) Appl. No.: 14/018,929

(22) Filed: Sep. 5, 2013

(30) Foreign Application Priority Data
Sep. 6, 2012 (GB) 1215940.6

(51) Int. Cl. H04N 7/30

(52) U.S. Cl. CPC H04N 19/00775
USPC 375/240.18

(57) ABSTRACT

In video encoding, a video input received in 4:2:2 is resampled. Residuals are formed through the use of reference samples stored in the native 4:2:2, before transforming, quantising and entropy coding to form an encoded bitstream in the resampled format. The encoded bitstream contains a message indicating chrominance resampling and a selected chrominance resampling filter for the decoder to use. An encoder may have a first mode in which the 4:2:2 is up-sampled to 4:4:4 and a second mode in which the 4:2:2 is down-sampled to 4:2:0.

### FIELD OF THE INVENTION

This invention is related to video compression and decompression systems in which chrominance information is sub-sampled relative to luminance information and in particular to such systems where the chrominance sub-sampling varies between horizontal and vertical directions.

### BACKGROUND OF THE INVENTION

It is well understood that since the human visual system is much more sensitive to variations in brightness than colour, a video compression system need devote less bandwidth to chrominance information (typically colour difference components Cb and Cr) than to luminance information, the luminance component being usually denoted Y. Using the standard format notation in which 4:4:4 indicates no chrominance sub-sampling, video compression systems commonly utilise 4:2:0 in which Cb and Cr are each sub-sampled at a factor of 2 both horizontally and vertically. In for example H.262/MPEG2 or H.264/AVC, a macro-block may contain four 8×8 luminance blocks but only one Cb block and only one Cr block.

In 4:2:0, (as well as of course in 4:4:4) there is uniform sampling of chrominance in both horizontal and vertical directions, that is to say the chrominance information is sampled at the same sample densities in the horizontal and vertical directions. In high quality professional applications (for example CCIR 601) it has long been common to employ 4:2:2 in which Cb and Cr are each sub-sampled at a factor of 2 in only the horizontal direction. Thus, chrominance information is sampled at different sample densities in the horizontal and vertical directions respectively.

It is an object of this invention to provide more efficient techniques in encoding and decoding to accommodate video formats such as 4:2:2 where chrominance chrominance information is sampled at different sample densities in the horizontal and vertical directions respectively.

### SUMMARY OF THE INVENTION

In one aspect, the present invention consists in a method of video encoding comprising the steps of receiving a video input in a first chrominance sampling format in which chrominance information is sampled at different sample densities in the horizontal and vertical directions respectively; resampling the video to a second chrominance sampling format in which the chrominance information is sampled at the same sample densities in the horizontal and vertical directions; forming residuals in which chrominance information is sampled in the second chrominance format through the use of reference samples in the first chrominance format; and transforming, quantising and entropy coding the residuals to form an encoded bitstream in the second chrominance sampling format. The encoded bitstream may contain a message indicating a chrominance resampling from the first chrominance sampling format.

Suitably, the encoder has a first mode of operation in which the second chrominance sampling format is up-sampled with respect to the first chrominance sampling format and a second mode of operation in which the second chrominance sampling format is down-sampled with respect to the first chrominance sampling format; and wherein a message in the encoded bitstream indicates the mode of operation.

The encoder may select between a plurality of chrominance resampling filters; wherein a message in the encoded bitstream indicates the selection of filter for the decoder

In another aspect, the present invention consists in a method of decoding an encoded bitstream comprising the steps of: receiving the encoded bitstream in a second chrominance sampling format in which the chrominance information is sampled at the same sample densities in the horizontal and vertical directions; performing inverse entropy coding, quantising and transforming steps to provide a residual in the second chrominance sampling format; reconstructing a video output from the residual and a predictor computed from decoded samples in a first chrominance format in which chrominance information is sampled at different sample densities in the horizontal and vertical directions respectively; and resampling to the first chrominance sampling format before or after said reconstruction.

Where the encoded bitstream contains a message indicating a chrominance resampling from the first chrominance sampling format; the step of receiving the encoded bitstream in the second chrominance sampling format may comprise decoding said message with the step of resampling to the first chrominance sampling format being conducted in response to said message. The resampling may switch in response to said message between down-sampling and up-sampling. The resampling may be conducted by a chrominance resampling filter selected in response to said message from a plurality of chrominance resampling filters.

Suitably, the step of resampling to the first chrominance sampling format is completed before said reconstruction. Alternatively, the step of resampling to the first chrominance sampling format is completed after said reconstruction and the predictor is resampled to the second chrominance sampling format.

In another aspects, the present invention consists in a video encoder configured to implement the above encoding method; a video decoder configured to implement the above decoding method; and a non-transitory computer program configured to cause programmable apparatus to implement either.

### BRIEF DESCRIPTION OF THE DRAWINGS

FIG. 1 is a block diagram of an encoder according to an embodiment:

FIG. 2 is a block diagram of a decoder according to an embodiment.

### DETAILED DESCRIPTION OF PREFERRED EMBODIMENTS

Video compression formats that have some components sub-sampled in only one direction (e.g. 4:1:1 or 4:2:2) are normally compressed in a way that such format is used as an input to the encoder and encoder's compression algorithms also operate on such sub-sampled chroma pixels. This invention proposes an alternative where, during encoding a video can be processed so that uniform sampling in both directions is achieved. To reconstruct the native format, during decoding an additional step is used to re-sample (down-sample or up-samples) decoded pixels. Such a video codec performs basic compression methods (transform, quantisation, entropy coding) on uniformly sampled signals. The benefits of such codec are:
Ensuring that the output of the decoder can provide sampling decided by the encoder and that each receiver obtains the same decoded video (which does not depend on a re-sampler that is unknown at the encoding, i.e. transmission side).
Preserving efficiency and simplicity of coding tools designed for uniform sampling.

Additional functionalities can be introduced which give more freedom for content adaptation during the compressed bitstream creation stage. These are introduced by for example allowing choice of down- or up-sampling filters which can be dynamically changed during compression. Decoding parameters can be adapted to provide desired decoding output.

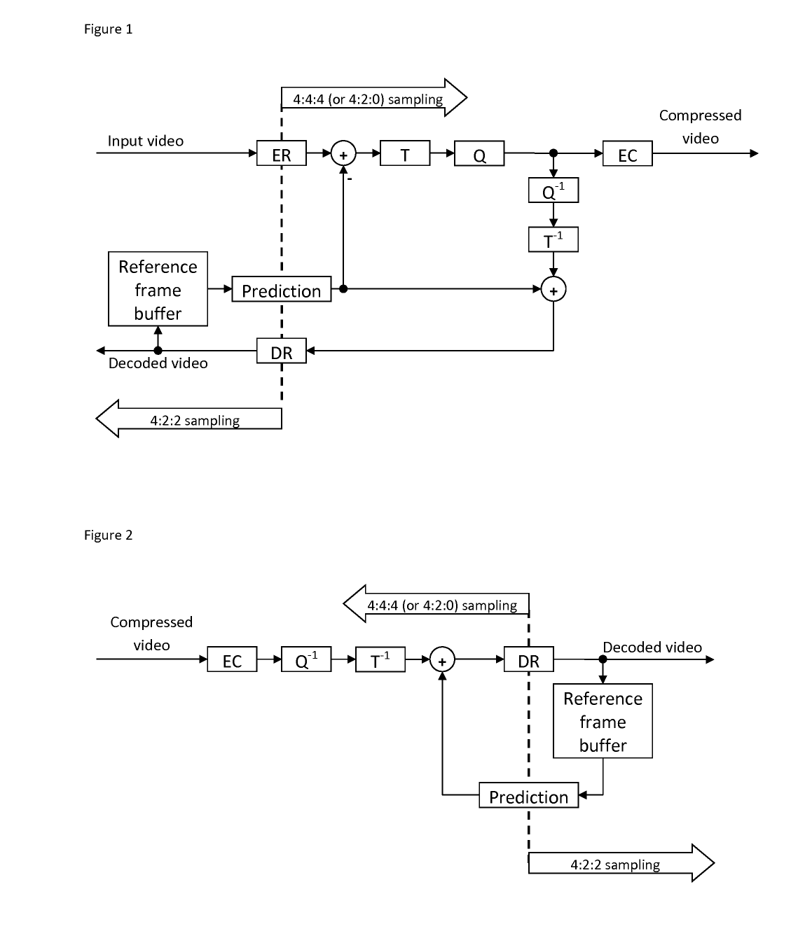

Reference is directed to FIG. 1 which shows an encoder which is adapted to receive input video in the 4:2:2 chrominance sampling format and which includes a chrominance resampling filter ER arranged so that the transform T, quantisation Q and entropy coding EC steps are performed in a chrominance sampling format in which the chrominance information is sampled at the same sample densities in the horizontal and vertical directions, such as 4:4:4 or 4:2:0. The compressed bitstream output is thus in chrominance sampling format in which the chrominance information is sampled at the same sample densities in the horizontal and vertical directions.

Within the local decoder provided at the encoder, there is a decoder re-sampler (DR). So, after inverse quantisation Q⁻¹ and inverse transformation T⁻² and addition of the previous prediction, the locally decoded video is resampled to 4:2:2 format before storage in the reference frame buffer which provides the reference samples for the prediction. At some point in the prediction path between the reference frame buffer and the subtractor which forms the residual for transformation at T, resampling will be conducted to ensure that the prediction which is subtracted is in the same chrominance sampling format as the resampled video from which it is subtracted.

Resampling will typically be chrominance up-sampling to 4:4:4.

It may be helpful for the encoder to have an additional mode of operation in which chrominance is down-sampled to 4:2:0. It may also be helpful for the encoder, whether up-sampling or down-sampling to have a selection of resampling filters available to it. The encoder may then make decisions on whether to up-sample or down-sample and on which resampling filter to select, based on video content or other relevant parameters and constraints. The encoder will signal its decisions to the decoder so that the decoder may employ complementary resampling. Specifically, format parameters signalling the use of re-sampling and—where appropriate—conveying information about the type of re-sampling (up or down); the chrominance re-sampling filter used and the nature of the prediction loop are provided to the entropy encoder and bit-stream forming block for incorporation in the bit-stream as a message.

An example of an application scenario is given in Table A which represents a compression timeline of video in 4:2:2 format. The sampling filter required at the decoder is communicated in the compressed bit-stream. The filter notation is used:
Eu=Encoder up-sampling filter
Dd=Decoder down-sampling filter
Ed=Encoder down-sampling filter
Du=Decoder up-sampling filter.

TABLE A

| Time | | | |
|---|---|---|---|
| period | Encoder | Decoder | Reason |
| A | Upsampling to | Downsampling to | High quality needed, |
| | 4:4:4 using | 4:2:2 using | which can be ensured |
| | filter Eu1 | filter Dd1 | using filter pair |
| | | | Eu1/Dd1 |
| B | Upsampling to | Downsampling to | For a required effect |
| | 4:4:4 using | 4:2:2 using | use other set of filters |
| | filter Eu2 | filter Dd2 | (Eu2/Dd2) |
| C | Downsampling to | Upsampling to | Rate control selects |
| | 4:2:0 using | 4:2:2 using | lower sampling rate to |
| | filter Ed1 | filter Du1 | achieve target bit-rate |
| D | Upsampling to | Downsampling to | Another effect |
| | 4:4:4 using | 4:2:2 using | achieved using filter |
| | filter Eu1 | filter Dd2 | pair Eu1/Dd2 |

Another simple scenario can also be achieved, as demonstrated in Table B. In this example, uniform sampling is achieved by repetition of pixels in the direction with lower sampling rate.
EuLL=Encoder up-sampling filter repeating vertical columns of pixels
DuLL=decoder down-sampling filter deleting repeated columns

TABLE B

| Time | | | |
|---|---|---|---|
| period | Encoder | Decoder | Reason |
| Whole | Upsampling to | Downsampling to | Lossless coding |
| duration of | 4:4:4 using | 4:2:2 using | |
| the video | filter EuLL | filter DdLL | |

Although core compression is performed on uniformly sampled video, the decoder receives a signal indicating decoding to another format (e.g. 4:2:2). The decoder is then capable of re-sampling the signal. For example,
In case of 4:2:2 format coded as 4:4:4, a simple approach of discarding half of samples related to Cb and Cr components in a normative way can be used.
In case of 4:2:2 format coded as 4:2:0, a simple approach of obtaining missing chroma samples can be achieved by averaging neighbouring samples in columns of chroma pixels.

Possibilities for decoder design include:
4:2:2 from 4:4:4:
   downsampling using default filter (e.g. example A)
   downsampling using a filter signalled by the encoder
      decoder has a number of downsampling filters; compressed bit-stream includes signalling on which filter to use for reconstruction
      decoder receives the filter description (e.g. by means of filter's coefficients), and uses a generic filtering module that performs filtering according to given filter choice
4:2:2 from 4:2:0:
   upsampling using default filter (e.g. example B)
   upsampling using a filter signalled by the encoder
      decoder has a number of upsampling filters; compressed bit-stream includes signalling on which filter to use for reconstruction
      decoder receives the filter description (e.g. by means of filter's coefficients), and uses a generic filtering module that performs filtering according to given filter choice

While such re-sampling can happen after full reconstruction of uniformly sampled video, a decoder as shown FIG. 2 provides a desirable alternative may be. It will be seen that the decoder resampling filter DR is positioned before the reference frame buffer. Thus some elements of the decoder operate on uniform samples (4:4:4 or 4:2:0); others operate on samples that are in the required sampling format for output (4:2:2).

Decoded frames in native 4:2:2 format are used for forming the prediction. On the other hand, the residual coming from the transform T is uniformly sampled. Therefore the prediction has to be resampled to uniform sampling. After this step of reconstruction, in which the prediction is added to the residual, the reconstructed frame is in uniformly sampled format. Before any full frame filtering and outputting of decoded video, the chroma samples are converted to the native 4:2:2 format.

An advantage of the arrangement shown in FIG. 3, where resampling occurs prior to reconstruction of the entire frame, is that the frame buffer or buffers that are required to store reconstructed frames for future use are (where up sampling to 4:4:4 is selected at the encoder) at a lower chrominance sampling rate.

It will be understood that this invention has been described by way of example only and a wide variety of modifications are possible without departing form the scope of the invention.

1. A method of video encoding comprising the steps of:
receiving a video input in a first chrominance sampling format in which chrominance information is sampled at different sample densities in the horizontal and vertical directions respectively;
resampling the video to a second chrominance sampling format in which the chrominance information is sampled at the same sample densities in the horizontal and vertical directions;
forming residuals in which chrominance information is sampled in the second chrominance format through the use of reference samples in the first chrominance format; and
transforming, quantising and entropy coding the residuals to form an encoded bitstream in the second chrominance sampling format.

2. A method according to claim 1, wherein the encoded bitstream contains a message indicating a chrominance resampling from the first chrominance sampling format.

3. A method according to claim 1, wherein the encoder has a first mode of operation in which the second chrominance sampling format is up-sampled with respect to the first chrominance sampling format and a second mode of operation in which the second chrominance sampling format is down-sampled with respect to the first chrominance sampling format; and wherein a message in the encoded bitstream indicates the mode of operation.

4. A system according to claim 1, in which the encoder selects between a plurality of chrominance resampling filters; wherein a message in the encoded bitstream indicates the selection of filter for the decoder.

5. A method of decoding an encoded bitstream comprising the steps of:
receiving the encoded bitstream in a second chrominance sampling format in which the chrominance information is sampled at the same sample densities in the horizontal and vertical directions;
performing inverse entropy coding, quantising and transforming steps to provide a residual in the second chrominance sampling format;
reconstructing a video output from the residual and a predictor computed from decoded samples in a first chrominance format in which chrominance information is sampled at different sample densities in the horizontal and vertical directions respectively; and
resampling to the first chrominance sampling format before or after said reconstruction.

6. A method according to claim 5, wherein
the encoded bitstream contains a message indicating a chrominance resampling from the first chrominance sampling format;
the step of receiving the encoded bitstream in the second chrominance sampling format comprises decoding said message; and
the step of resampling to the first chrominance sampling format is conducted in response to said message.

7. A method according to claim 6, wherein the resampling switches in response to said message between down-sampling and up-sampling.

8. A method according to claim 6, wherein the resampling is conducted by a chrominance resampling filter selected in response to said message from a plurality of chrominance resampling filters.

9. A non-transitory computer program product configured to cause programmable apparatus to implement a method of decoding an encoded bitstream comprising the steps of: receiving the encoded bitstream in a second chrominance sampling format in which the chrominance information is sampled at the same sample densities in the horizontal and vertical directions; performing inverse entropy coding, quantising and transforming steps to provide a residual in the second chrominance sampling format; reconstructing a video output from the residual and a predictor computed from decoded samples in a first chrominance format in which chrominance information is sampled at different sample densities in the horizontal and vertical directions respectively; and resampling to the first chrominance sampling format before or after said reconstruction.

10. A non-transitory computer program product according to claim 9, wherein the encoded bitstream contains a message indicating a chrominance resampling from the first chrominance sampling format; the step of receiving the encoded bitstream in the second chrominance sampling format comprises decoding said message; and the step of resampling to the first chrominance sampling format is conducted in response to said message.

11. A non-transitory computer program product according to claim 9, wherein the resampling switches in response to said message between down-sampling and up-sampling.

12. A non-transitory computer program product according to claim 9, wherein the resampling is conducted by a chrominance resampling filter selected in response to said message from a plurality of chrominance resampling filters.
